(19) United States
(12) Patent Application Publication
(10) Pub. No.: US 2025/0119484 A1
(43) Pub. Date: Apr. 10, 2025

(54) Differentiated handling of packets containing message headers

(71) Applicant: Mellanox Technologies, Ltd., Yokneam (IL)

(72) Inventor: Boris Pismenny, Haifa (IL)

(21) Appl. No.: 18/483,547

(22) Filed: Oct. 10, 2023

(51) Int. Cl. H04L 69/22; H04L 47/2408

(52) U.S. Cl. CPC H04L 69/22; H04L 47/2408; H04L 2212/00

(57) ABSTRACT

A method for data communication includes receiving messages comprising data for transmission over a packet communication network to a specified destination address and encoding the messages in a series of data records having respective record headers. The data records are encapsulated in respective payloads of a sequence of data packets such that at least some of the data records span multiple consecutive data packets in the sequence. A quality of service (QoS) field in a respective packet header of each data packet in the sequence is set to a first value when a payload of the data packet contains one of the record headers and otherwise to a second value, different from the first value. The sequence of data packets is transmitted over the packet communication network to the specified destination address.

### FIELD

The present invention relates generally to computer systems, and particularly to computational accelerator devices and methods.

### BACKGROUND

Computational accelerators are commonly used in offloading computation-intensive tasks from the central processing unit (CPU, also referred to as the host processor) of a host computer. Such accelerators typically comprise hardware logic that is dedicated to a particular type of operations, such as cryptography or data compression, and can thus perform these operations much faster than software-driven computation by the CPU. When an accelerator is to be used in processing the payloads of a stream of data packets, however, it may have to implement not only its intended computational function, but also packet header processing and communication protocol logic.

For example, U.S. Pat. No. 10,135,739, whose disclosure is incorporated herein by reference, describes a data processing device that includes a first packet communication interface for communication with at least one host processor via a network interface controller (NIC) and a second packet communication interface for communication with a packet data network. A memory holds a flow state table containing context information with respect to multiple packet flows conveyed between the host processor and the network via the first and second packet communication interfaces. Acceleration logic, coupled between the first and second packet communication interfaces, performs computational operations on payloads of packets in the multiple packet flows using the context information in the flow state table.

As another example, U.S. Pat. No. 11,005,771, whose disclosure is incorporated herein by reference, describes a computational accelerator for packet payload operations.

According to this patent, packet processing apparatus includes a first interface coupled to a host processor and a second interface configured to transmit and receive data packets to and from a packet communication network. A memory holds context information with respect to one or more flows of the data packets conveyed between the host processor and the network in accordance with a reliable transport protocol and with respect to encoding, in accordance with a session-layer protocol, of data records that are conveyed in the payloads of the data packets in the one or more flows. Processing circuitry, coupled between the first and second interfaces, transmits and receives the data packets and includes acceleration logic, which encodes and decodes the data records in accordance with the session-layer protocol using the context information while updating the context information in accordance with the serial numbers and the data records of the transmitted data packets.

### SUMMARY

Embodiments of the present invention that are described hereinbelow provide improved devices and methods for computational acceleration in a computer system.

There is therefore provided, in accordance with an embodiment of the invention, packet processing apparatus, including a first interface to be coupled to a host processor having a memory and a second interface to be coupled to a packet communication network. One or more packet processing circuits receive messages including data from the memory via the first interface for transmission over the packet communication network to a specified destination address, encode the messages in a series of data records having respective record headers, and encapsulate the data records in respective payloads of a sequence of data packets such that at least some of the data records span multiple consecutive data packets in the sequence. A quality of service (QoS) field is set in a respective packet header of each data packet in the sequence to a first value when a payload of the data packet contains one of the record headers. Otherwise, the QoS field is set to a second value, different from the first value, and to transmit the sequence of data packets via the second interface over the packet communication network to the specified destination address.

In some embodiments, the first and second values of the QoS field are selected such that the data packets having the first value of the QoS field are less likely to be dropped by components in the packet communication network than the data packets having the second value of the QoS field.

In one embodiment, the QoS field is a differentiated services field in an Internet Protocol (IP) header of the data packets. Alternatively, the QoS field is a class of service field in an Ethernet header of the data packets. Further alternatively, the QoS field includes experimental bits in a multiprotocol label switching (MPLS) header of the data packets.

In some embodiments, the one or more packet processing circuits are to encode the messages in accordance with a session-layer protocol. In one embodiment, encoding the messages includes encrypting the data records in accordance with the session-layer protocol, such as a Transport Layer Security (TLS) protocol. Alternatively or additionally, encoding the messages includes adding tags to the data records in accordance with the session-layer protocol. In a disclosed embodiment, each tag includes a digest of a corresponding data record.

In some embodiments, the one or more packet processing circuits are to encapsulate and transmit the data records in accordance with a reliable transport protocol, such as a Transmission Control Protocol (TCP).

There is also provided, in accordance with an embodiment of the invention, a method for data communication, which includes receiving messages including data for transmission over a packet communication network to a specified destination address and encoding the messages in a series of data records having respective record headers. The data records are encapsulated in respective payloads of a sequence of data packets such that at least some of the data records span multiple consecutive data packets in the sequence. A quality of service (QoS) field in a respective packet header of each data packet in the sequence is set to a first value when a payload of the data packet contains one of the record headers and otherwise to a second value, different from the first value. The sequence of data packets is transmitted over the packet communication network to the specified destination address.

In one embodiment, the sequence of the data packets is transmitted by a network interface controller (NIC) in response to receiving the messages from a host processor, and the QoS field is set by the host processor under control of software running on the host processor. Alternatively or additionally, the QoS field is set by the NIC.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a computer system with a computational accelerator, in accordance with an embodiment of the invention;

FIG. 2 is a block diagram that schematically illustrates framing of data processed by a computational accelerator in a sequence of packets, in accordance with an embodiment of the invention; and

FIG. 3 is a flow chart that schematically illustrates a method for generation and transmission of data packets by a computational accelerator, in accordance with an embodiment of the invention.

### DETAILED DESCRIPTION

### Overview

As noted earlier, computational accelerators for packet processing, such as a cryptographic accelerator, are often required to implement not only their intended computational functions, but also packet header processing and communication protocol logic. For stateless link-layer and network-layer protocols, such as Ethernet and Internet Protocol (IP), this logical burden is manageable. Connection-oriented transport protocols, such as the Transmission Control Protocol (TCP), however, are more complex and difficult to offload to a hardware-based computational accelerator. Specifically, it is difficult for the accelerator to handle situations in which packets are lost or received out of order at their destinations. The difficulty can be even more severe when attempting to offload session-layer protocols, such as cryptographic operations involved in session-layer encryption solutions, for example the Secure Sockets Layer (SSL) and Transport Layer Security (TLS), and computation of digest tags for purposes of authentication and error detection.

The present embodiments are directed particularly to computational accelerators for use in encoding payload data in accordance with a session layer protocol, for transmission over a network in packet flows that are transmitted using a reliable transport protocol, as well as in receiving and decoding such payload data. The term “reliable transport protocol” refers to packet communication protocols in Layer 4 of the Open Systems Interconnection (OSI) model, such as TCP, which verify reception of packets and include a mechanism for retransmission of packets that are not received at the intended destination. Such protocols typically assign to the packets respective serial numbers, which are incorporated in the packet headers.

The term “session-layer protocol” is used herein to refer to protocols that run above the transport layer and are used by the transmitting and the receiving computers in establishing the context for a communication session that can extend over multiple packets. In the present case, this context is used by the transmitting computer in framing and encoding data records that are to be conveyed in the payloads of the packets in a reliable transport flow. The term “record” refers to a segment of data of a specified length, with the possible addition of metadata pertaining to the data segment. (This is the meaning of the term “record” that is used in TLS specifications, for example.) Typically, each record comprises a header containing at least some of the metadata. In some cases, the record may also comprise a tag containing additional metadata, such as an error-correcting code or message digest.

The term “encoding” as used herein refers to computational operations that are applied to the data records before transmission by the transmitting computer, using the session-layer context, while “decoding” refers to the reverse operations that are performed by the receiving computer. In the embodiments that are described below, the encoding comprises an encryption of the data in each record, for example, using the TLS protocol, while decoding comprises decryption. In other embodiments, the encoding operations may alternatively or additionally comprise computation of a tag, such as a digest, digital signature, or error-correction code, over a data frame; data compression; or other computations that depend on the session context.

In some session-layer protocols, the data records can have respective lengths that are larger than the maximum packet payload size, meaning that at least some of the encoded data records will span multiple consecutive data packets. Thus, in order to encode or decode a given data record, the session context information is maintained and updated over multiple consecutive data packets in order. As a result, when a packet is received out of order or is lost in transmission, the context information may be lost.

The above-mentioned U.S. Pat. No. 11,005,771 describes computational accelerators that are capable of autonomously reconstructing the lost context information in such situations. The accelerators use this context information in handling packet retransmission and in handling packets that are received out of order without involving the CPU. Even so, reconstructing lost context places a burden on the accelerator, as well as on other computer resources, such as bus and memory bandwidth, that are consumed by the accelerator.

The present embodiments are directed to alleviating this burden by reducing the need for reconstruction of session-layer context, even when packets are transmitted over networks that are prone to packet loss. These embodiments are based on the realization that when a session-layer data record spans multiple consecutive data packets, the session-layer context information that the receiving node will use in decoding the data record is contained in the packet that contains the record header. Loss of the packet that contains the record header will require the accelerator receiving the record to invest substantial computational effort in reconstructing the context. On the other hand, loss of packets containing other parts of the record can be handled by simpler mechanisms of packet retransmission and out-of-order packet placement, for example mechanisms associated with transport-layer protocols, such as TCP.

Based on this realization, the present embodiments use existing network packet forwarding protocols to reduce the likelihood that packets containing record headers will be lost. For this purpose, a quality of service (QoS) field is set in the packet headers of the packets containing record headers to a first value, while the QoS field is set to a second value in packets that do not contain record headers. The first and second QoS values are chosen such that components in the network, such as switches and/or routers, are less likely to drop packets with the first QoS value than packets with the second QoS value, i.e., the first QoS receives higher priority than the second QoS. In this manner, existing packet forwarding and QoS capabilities of network components are used to facilitate session-layer acceleration on the receive side of the connection.

The embodiments that are described below provide packet processing apparatus, such as a NIC, which comprises a first interface coupled to a host processor and a second interface coupled to a packet communication network. Processing circuitry in the apparatus receives messages comprising data from the host memory via the first interface, for transmission over the packet communication network to a specified destination address. The processing circuitry encodes the messages in a series of data records having respective record headers, for example using a session-layer protocol. The processing circuitry encapsulates the data records in respective payloads of a sequence of data packets, for example packets to be transmitted in accordance with a reliable transport protocol. At least some of the encoded data records span multiple consecutive data packets in the sequence.

In these embodiments, the processing circuitry sets a QoS field in the respective packet header of each data packet in the sequence to a first value when the payload of the data packet contains one of the record headers and otherwise sets the QoS field to a different, second value. Various sorts of link-layer and network-layer protocols and QoS fields can be used for this purpose. For example, the QoS field may be a differentiated services field in an IP header of the data packets; a class of service field in an Ethernet header of the data packets; or a set of experimental bits in a multiprotocol label switching (MPLS) header of the data packets. The processing circuitry then transmits the sequence of data packets via the second interface over the packet communication network to the specified destination address.

In these embodiments and in the embodiments that are described hereinbelow, in other words, the QoS field is set by the NIC that transmits the sequence of data packets. In alternative embodiments, the QoS field is set by the host processor under control of software running on the host processor. Further alternatively, the QoS field may be set by another hardware or software-driven component on the transmitting side of the communication connection. All these modes of implementation are considered to be within the scope of the present invention.

Furthermore, although the embodiments described below are directed specifically to generation and transmission of packets containing TLS records, the principles of the present invention may similarly be applied, mutatis mutandis, in transmitting packets that are encoded in accordance with other session-layer protocols. In alternative embodiments, for example, the session-layer protocol may be used to compress the data records and/or to add tags to the data records, such as tags that comprise a digest of the data in the corresponding data record for purposes of authentication or error detection. All such alternative implementations are considered to be within the scope of the present invention.

### System Description

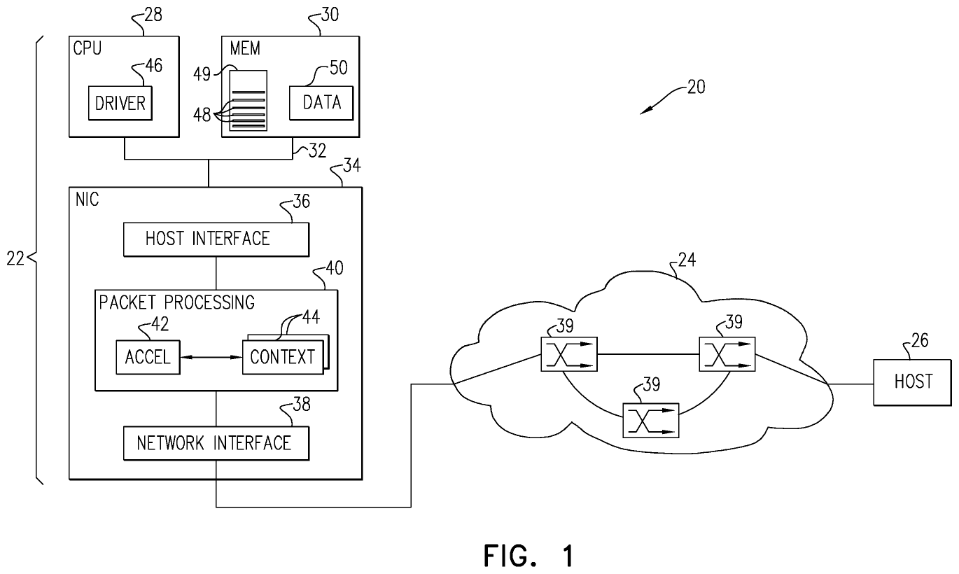

FIG. 1 is a block diagram that schematically illustrates a computer system 20 with a computational accelerator 42, in accordance with an embodiment of the invention. System 20 comprises a host computer 22, which is connected to communicate over a packet data network 24 with other computers, such as a host computer 26. Network 24 comprises multiple forwarding devices 39, such as switches or routers, operating in accordance with an appropriate packet communication protocol such as Ethernet (based on the IEEE 802.3 family of standards), IP or MPLS, for example. Forwarding devices 39 implement a QoS protocol in choosing packets to be dropped in case of congestion or other unfavorable conditions. (It is desirable that the QoS protocol not prioritize packets for forwarding based on the value of the QoS field in the packet headers in order to reduce the likelihood that packets will be forwarded out of order.)

Computer 22 comprises a CPU 28 with a host memory 30, typically comprising random-access memory (RAM). CPU 28 and memory 30 are connected to a NIC 34 by a suitable bus 32, such as a PCI Express® (PCIe®) bus. Computer 26 typically comprises similar components.

NIC 34 comprises a network interface 38 in the form of one or more physical network ports configured for connection to network 24. NIC 34 is connected to bus 32 through a host interface 36, comprising a suitable PCIe interface, for example. Processing circuitry 40 in NIC 34 is connected between network interface 38 and host interface 36 and handles both incoming packets received from network 24 and outgoing packets for transmission to network 24, as described in greater detail hereinbelow.

In the pictured embodiment, accelerator 42 is implemented as a part of packet processing circuitry 40 and handles encryption and decryption functions in accordance with the TLS protocol, in response to instructions conveyed by driver software 46 running on CPU 28. For this purpose, accelerator 42 maintains context data 44 in a memory for each TCP flow that it has been instructed to handle. Context data 44 may be held in a memory within NIC 34 and/or on a separate, dedicated memory chip and/or in a partition of host memory 30 that is assigned for this purpose. The context data for each such flow include:
The TCP packet context, including the 5-tuple of fields in the IP packet header (IP source and destination addresses, IP source and destination ports, and the protocol) and the next expected TCP packet serial number (PSN).
The TLS record context, including the record length and sequence number of the current record.
The cryptographic state, including the cryptographic keys, initialization vector (IV), and current state of the cipher.

These context values are initially downloaded to NIC 34 by software 46 for each new TLS session (transmitted or received) that the NIC is to handle. The values are then updated by accelerator 42 each time a new packet in the flow is transmitted or received. Only a subset of the values is actually updated, however, such as the TCP PSN and cipher state for each packet, and the TLS sequence number of each new record. The other context values are generally constant over the entire session.

For the sake of clarity, the physical components of NIC 34 are shown in FIG. 1 as multiple, separate functional blocks. In practice, however, these components are typically (although not necessarily) implemented as hardware and firmware components within a single integrated circuit chip or chipset, possibly together with CPU 28, as well. Processing circuitry 40 typically comprises hardware logic circuits, which may be programmable or hard-wired and are configured to carry out the functions described herein, as well as other packet processing functions that are known in the art. Additionally or alternatively, at least some of these functions can be carried out by an embedded processor in NIC 34 under the control of software or firmware.

Accelerator 42 typically comprises control logic, which is responsible for packet handling and data transfer within the accelerator, and an arithmetic logic unit, which performs cryptographic computational operations on payloads of outgoing and incoming packets that are received through interfaces 36 and 38. In the present embodiment, these operations include encryption and decryption of messages, as well as recovery of context data 44 in case of retransmission or packet loss. Details of these operations for the case of TLS are presented in the above-mentioned U.S. Pat. No. 11,005,771 and are beyond the scope of the present description.

To transmit data packets to network, communication software, such as a TCP/IP protocol stack, running on CPU 28 writes descriptors 48 to a queue 49. The descriptors (also referred to as work requests or work queue elements, for example) specify the location of packet data in a buffer 50 in memory 30 and operations to be applied in transmission of the packets, such as encryption of TLS records to be carried in the packet payloads. Although the large majority of the packets will be transmitted with their TCP serial numbers in order, CPU 28 will occasionally post a descriptor 48 calling for retransmission of a previous packet, for example, when host computer 26 has failed to acknowledge the packet.

When NIC 34 receives encrypted packets from network 24, accelerator 42 applies appropriate context data 44 in decrypting the packet payloads. Processing circuitry 40 then writes the decrypted packets to a specified location in buffer 50. As in the case of packet transmission, packets are generally received from network 24 in serial order within their respective flows (for example, flows of TCP packets), so that accelerator 42 is able to maintain valid context data 44 from one packet to the next. When a packet in a given flow is received out of order, accelerator 42 searches the payloads of the packets in the given flow (typically beginning with the out-of-order packet) in order to find TLS record headers, and then reconstructs context data 44 using these headers. Further details of this reconstruction process are also provided in the above-mentioned U.S. Pat. No. 11,005,771. In the present embodiments, however, the packets containing TLS record headers are unlikely to be lost in transmission through network 24, and the need for context reconstruction by processing circuitry 40 will therefore be alleviated or possibly eliminated entirely.

Although FIG. 1 shows one possible implementation of accelerator 42, other implementations will be apparent to those skilled in the art after reading the present description and are considered to be within the scope of the present invention. For example, accelerator 42 may be implemented in a bump-in-the-wire configuration, as described in the above-mentioned U.S. Pat. No. 10,135,739, rather than as a part of the NIC.

### Processing of Transmitted Packets

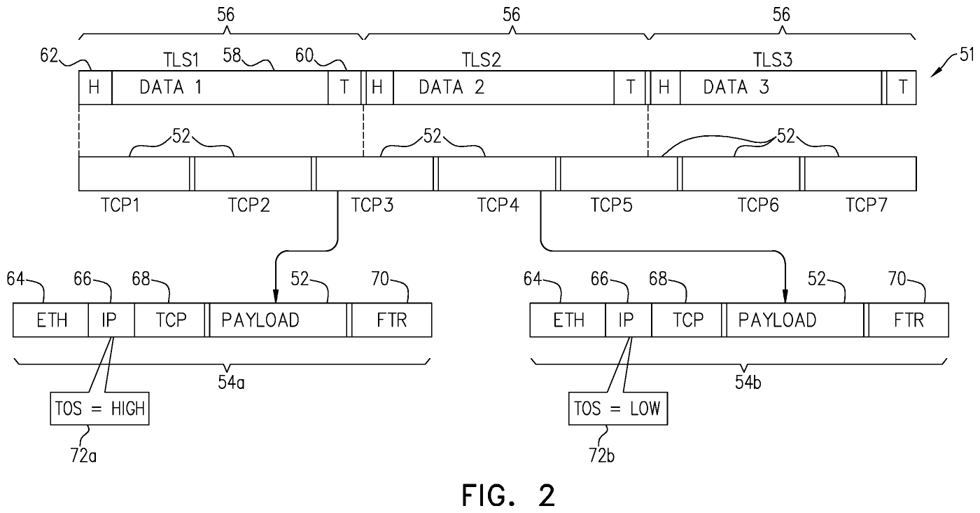

FIG. 2 is a block diagram that schematically illustrates framing of a stream of data 51 processed by accelerator 42 and transmitted by NIC 34 in a sequence of packets 54, in accordance with an embodiment of the invention. Data 51 in this example are encapsulated and encrypted in a sequence of records 56, in accordance with the TLS protocol and record format, as described for example in a number of requests for comments (RFCs) of the Internet Engineering Task Force (IETF), including RFC 5246 (2008), RFC 6176 (2011) and RFC 8446 (2018), which are incorporated herein by reference. Following these operations, TLS records 56 are transmitted in payloads 52 of a sequence of TCP packets 54a, 54b, (referred to collectively as packets 54).

Software running on CPU 28 divides the stream of data 51, which is initially held in memory 30, into a sequence of frames 58 of a given length, which can be up to 16 KB. The software also defines packets 54, including the length of payloads 52 and some or all of the fields in the packet headers. Driver software 46 writes descriptors 48 to queue 49, specifying the addresses and lengths of data frames 58 that processing circuitry 40 is to read from memory 30, as well as packet parameters, such as the TCP payload size and packet serial numbers. Because the size of frames 58 is greater than the size of payloads 52, the lengths of data records 56 span multiple consecutive packets 54. Thus, for example, the data record marked TLS2 spans the payloads of TCP packets TCP3, TCP4 and TCP5.

Upon receiving a descriptor 48 identifying data 51 and corresponding packets 54 for transmission, accelerator 42 reads each successive frame 58, adds an (optional) authentication tag 60, and encrypts the data as specified by the applicable TLS standards, using context data 44. The context data include both the encryption key and other parameters that are used in computing the cipher. Either CPU 28 or accelerator 42 also adds a header 62 to each record 56, including a version field and a record length field, in accordance with TLS standards. The algorithms for encryption and decryption that are applied by accelerator 42 are described in the above-mentioned U.S. Pat. No. 11,005,771 and are beyond the scope of the present description.

Processing circuitry 40 breaks encrypted TLS records 56 into TCP payloads 52, and inserts the payloads into successive packets 54 for transmission to network 24. In accordance with TCP/IP standards, each packet has Ethernet and IP headers 64 and 66, followed by a TCP header 68, containing the packet serial number (PSN). The updated PSN value is held in context data 44 to verify that the correct cipher state is used in encrypting each successive frame 58 of data. Processing circuitry 40 also adds a footer 70 to each packet in accordance with the applicable standards.

Furthermore, processing circuitry 40 checks the contents of payload 52 of each packet 54 to determine which payloads contain record headers 62. In the example shown in FIG. 2, packet 54a contains header 62 of record TLS2, whereas packet 54b contains only data, without a header. Processing circuitry 40 sets the value of type of service (TOS) bits 72 in the Differentiated Services Code Point (DSCP) field of IP header 66 in each packet 54 according to whether or not the packet payload 52 contains a record header. Thus, TOS bits 72a in packet 54a, which contains record header 62, are set to a value corresponding to a high-priority QoS, whereas TOS bits 72b in packet 54b are set to a value corresponding to a lower-priority QoS. As noted earlier, packets 54 having TOS bits 72a are less likely to be dropped by forwarding devices 39 in network 24 than are packets having TOS bits 72b.

Alternatively or additionally, processing circuitry 40 may set the values of other QoS-related fields in the headers of packets 54 based on similar criteria. For example, the processing circuitry may set a class of service (COS) field in Ethernet headers 64 or may set experimental bits in MPLS headers of the packets (not shown in the figures).

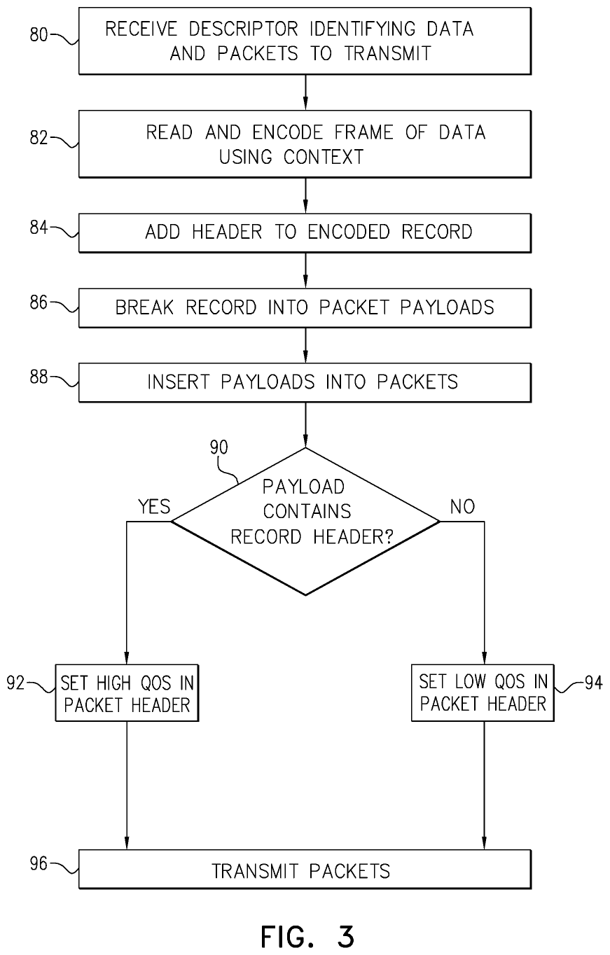

FIG. 3 is a flow chart that schematically illustrates a method for processing of packets for transmission to network 24 by accelerator 42, in accordance with an embodiment of the invention. To initiate the method, driver software 46 running on CPU 28 posts a descriptor 48 in queue 49, identifying a message comprising data in memory 30 and packets that are to be transmitted containing the data. When descriptor 48 reaches the head of queue 49, processing circuitry 40 reads the descriptor, at a transmission initiation step 80. Processing circuitry 40 reads the data from buffer 50 in memory 30 and passes it to accelerator 42 for handling. Accelerator 42 uses the corresponding context data 44 to encode frames 58 of data in a series of data records 56, at an encoding step 82. The accelerator adds a record header 62 to each record, at a header application step 84.

Processing circuitry 40 breaks records 56 into multiple payloads 52, at a payload generation step 86, and then inserts the payloads into a sequence of data packets 54, at a packet generation step 88. The processing circuitry checks each packet 54 to determine whether it contains a record header 62, at a payload checking step 90. If so (as in packet 54a, for example), processing circuitry 40 sets a QoS field in the packet header to a value corresponding to high priority of transmission and low drop probability, at a high QoS setting step 92. Otherwise (as in packet 54b, for example), the processing circuitry sets the QoS to a low-priority value, at a low QoS setting step 94. NIC 34 then transmits packets 54 via network interface 38 to network 24, at a packet transmission step 96.

The embodiments described above are cited by way of example, and the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Packet processing apparatus, comprising:
a first interface to be coupled to a host processor having a memory;
a second interface to be coupled to a packet communication network; and
one or more packet processing circuits, to receive messages comprising data from the memory via the first interface for transmission over the packet communication network to a specified destination address, to encode the messages in a series of data records having respective record headers, to encapsulate the data records in respective payloads of a sequence of data packets such that at least some of the data records span multiple consecutive data packets in the sequence, to set a quality of service (QoS) field in a respective packet header of each data packet in the sequence to a first value when a payload of the data packet contains one of the record headers and otherwise to set the QoS field to a second value, different from the first value, and to transmit the sequence of data packets via the second interface over the packet communication network to the specified destination address.

2. The apparatus according to claim 1, wherein the first and second values of the QoS field are selected such that the data packets having the first value of the QoS field are less likely to be dropped by components in the packet communication network than the data packets having the second value of the QoS field.

3. The apparatus according to claim 1, wherein the QoS field is a differentiated services field in an Internet Protocol (IP) header of the data packets.

4. The apparatus according to claim 1, wherein the QoS field is a class of service field in an Ethernet header of the data packets.

5. The apparatus according to claim 1, wherein the one or more packet processing circuits are to encode the messages in accordance with a session-layer protocol.

6. The apparatus according to claim 1, wherein the one or more packet processing circuits are to encapsulate and transmit the data records in accordance with a reliable transport protocol.

7. A method for data communication, comprising:
receiving messages comprising data for transmission over a packet communication network to a specified destination address;
encoding the messages in a series of data records having respective record headers;
encapsulating the data records in respective payloads of a sequence of data packets such that at least some of the data records span multiple consecutive data packets in the sequence;
setting a quality of service (QoS) field in a respective packet header of each data packet in the sequence to a first value when a payload of the data packet contains one of the record headers and otherwise to a second value, different from the first value; and
transmitting the sequence of data packets over the packet communication network to the specified destination address.

8. The method according to claim 7, wherein the first and second values of the QoS field are selected such that the data packets having the first value of the QoS field are less likely to be dropped by components in the packet communication network than the data packets having the second value of the QoS field.

9. The method according to claim 7, wherein the QoS field is a differentiated services field in an Internet Protocol (IP) header of the data packets.

10. The method according to claim 7, wherein the QoS field is a class of service field in an Ethernet header of the data packets.

11. The method according to claim 7, wherein the QoS field comprises experimental bits in a multiprotocol label switching (MPLS) header of the data packets.

12. The method according to claim 7, wherein encoding the messages comprises encoding the messages in accordance with a session-layer protocol.

13. The method according to claim 12, wherein encoding the messages comprises encrypting the data records in accordance with the session-layer protocol.

14. The method according to claim 13, wherein the session-layer protocol comprises a Transport Layer Security (TLS) protocol.

15. The method according to claim 12, wherein encoding the messages comprises adding tags to the data records in accordance with the session-layer protocol.

16. The method according to claim 15, wherein each tag comprises a digest of a corresponding data record.

17. The method according to claim 7, wherein encapsulating the data records comprises encapsulating the data records in the data packets for transmission in accordance with a reliable transport protocol.

18. The method according to claim 17, wherein the reliable transport protocol comprises a Transmission Control Protocol (TCP).

19. The method according to claim 7, wherein the sequence of the data packets is transmitted by a network interface controller (NIC) in response to receiving the messages from a host processor, and wherein the QoS field is set by the host processor under control of software running on the host processor.

20. The method according to claim 7, wherein the sequence of the data packets is transmitted by a network interface controller (NIC) in response to receiving the messages from a host processor, and wherein the QoS field is set by the NIC.
